(19) United States
(12) Patent Application Publication
(10) Pub. No.: US 2017/0045363 A1
(43) Pub. Date: Feb. 16, 2017

(54) PATH GRAPH GENERATION METHOD, PATH GRAPH GENERATION DEVICE AND STORAGE MEDIUM

(71) Applicant: FUJITSU LIMITED, Kawasaki-shi (JP)

(72) Inventors: Tatsuya Asai, Kawasaki (JP); Junichi Shigezumi, Kawasaki (JP); Hiroya INAKOSHI, Tama (JP)

(73) Assignee: FUJITSU LIMITED, Kawasaki-shi (JP)

(21) Appl. No.: 15/179,373

(22) Filed: Jun. 10, 2016

(30) Foreign Application Priority Data
Aug. 12, 2015 (JP) 2015-159476

(51) Int. Cl. G01C 21/32; G01S 19/13; G01C 21/20

(52) U.S. Cl. CPC G01C 21/32; G01C 21/206; G01S 19/13

(57) ABSTRACT

A path graph generation method executed by a processor included in a path graph generation device, the method includes acquiring a plurality of pieces of locus information regarding a plurality of moving bodies, the locus information including each information on a plurality of positions acquired at predetermined time intervals, each of the plurality of positions being associated with a label indicating a belonging area; determining, for each of the plurality of pieces of locus information, whether to integrate two or more positions having an each other's distance less than or equal to a predetermined distance among the plurality of positions into one position, based on the label associated with each of the two or more positions; and setting the one position to a node position and thereby generating the path graph, when it is determined to integrate the two or more positions into the one position.

### CROSS-REFERENCE TO RELATED APPLICATION

This application is based upon and claims the benefit of priority of the prior Japanese Patent Application No. 2015-159476, filed on Aug. 12, 2015, the entire contents of which are incorporated herein by reference.

### FIELD

The embodiments discussed herein are related to a path graph generation method, a path graph generation device, and a storage medium.

### BACKGROUND

In analyzing locus data of a moving body, which has been collected by a sensor, such as a Global Positioning System (GPS) device, or the like, techniques for creating a path graph from the locus data are disclosed. For example, a technique has been proposed for creating a path graph by integrating a plurality of locus data that are close in distance with each other. It is possible to analyze, for example, a flow rate, or the like of a moving body for each path using the created path graph. As the related art, for example, Japanese Laid-open Patent Publication No. 2015-76069, and the like are disclosed.

However, for example, for certain two moving bodies, even if the distance between the moving bodies, which is indicated by respective locus data, is short, there are cases where the moving bodies exist in physically or conceptually different areas. In this case, it may not be possible to make an analysis in consideration of the difference in physically or conceptually different areas using a path graph created by integrating the locus data of the two moving bodies into the same path. Accordingly, it is desirable to create a path graph in consideration of the difference in the areas.

### SUMMARY

According to an aspect of the invention, a path graph generation method executed by a processor included in a path graph generation device, the method includes acquiring a plurality of pieces of locus information regarding a plurality of moving bodies, the locus information including each information on a plurality of positions acquired at predetermined time intervals, each of the plurality of positions being associated with a label indicating a belonging area; determining, for each of the plurality of pieces of locus information, whether to integrate two or more positions having an each other's distance less than or equal to a predetermined distance among the plurality of positions into one position, based on the label associated with each of the two or more positions; and setting the one position to a node position and thereby generating the path graph, when it is determined to integrate the two or more positions into the one position.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating a schematic configuration of a path graph generation device according to the present embodiment;

FIG. 2 is a diagram for explaining generation of a path graph in the case of not considering the difference in areas;

FIG. 3 is a diagram for explaining integration of locus data into a path graph in the case of not considering the difference in areas;

FIG. 4 is a diagram illustrating an example of loci illustrated by locus data;

FIG. 5 is a diagram illustrating an example of a locus data set;

FIG. 6 is a diagram illustrating an example of a path graph;

FIG. 7 is a diagram illustrating an example of a data structure of a path graph;

FIG. 8 is a block diagram illustrating a schematic configuration of a computer that functions as the path graph generation device according to the present embodiment;

FIG. 9 is a flowchart illustrating an example of path graph generation processing in the present embodiment;

FIG. 10 is a flowchart illustrating an example of path graph update processing;

FIG. 11 is a diagram for explaining integration of locus data t₁ into a path graph;

FIG. 12 is a diagram for explaining integration of locus data t₂ into a path graph;

FIG. 13 is a diagram for explaining integration of locus data t₃ into a path graph;

FIG. 14 is a diagram for explaining integration of locus data t₄ into a path graph;

FIG. 15 is a diagram for explaining integration of locus data t₅ into a path graph; and

FIG. 16 is a diagram for explaining integration of locus data t₆ into a path graph.

### DESCRIPTION OF EMBODIMENTS

First, a description will be given of problems in the case of generating a path graph without considering the difference in areas at the time of generating a path graph before giving a detailed description of the embodiments.

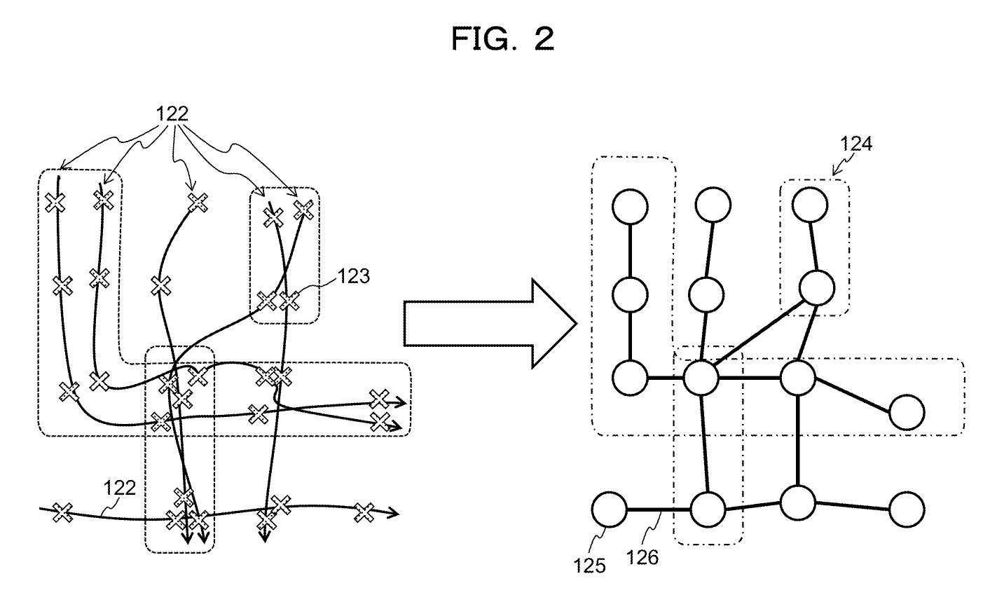

FIG. 2 schematically illustrates an example of creating a path graph 124 by integrating plural locus data having a short distance with each other among a plurality of locus data 122. As illustrated on the left side diagram in FIG. 2, each of the locus data 122 is a series of positions (observation points 123, x marks in FIG. 2) of a moving body, which are observed by a sensor, such as a Global Positioning System (GPS) device, or the like at predetermined time intervals, and is data representing a locus of the movement of a moving body. As illustrated on the right side of FIG. 2, a path graph is a graph indicated by a plurality of nodes 125 and edges 126 that connects the nodes. In the example in FIG. 2, parts illustrated by broken lines of a plurality of locus data 122 are integrated into parts as illustrated by dash-single-dot lines in a path graph 124.

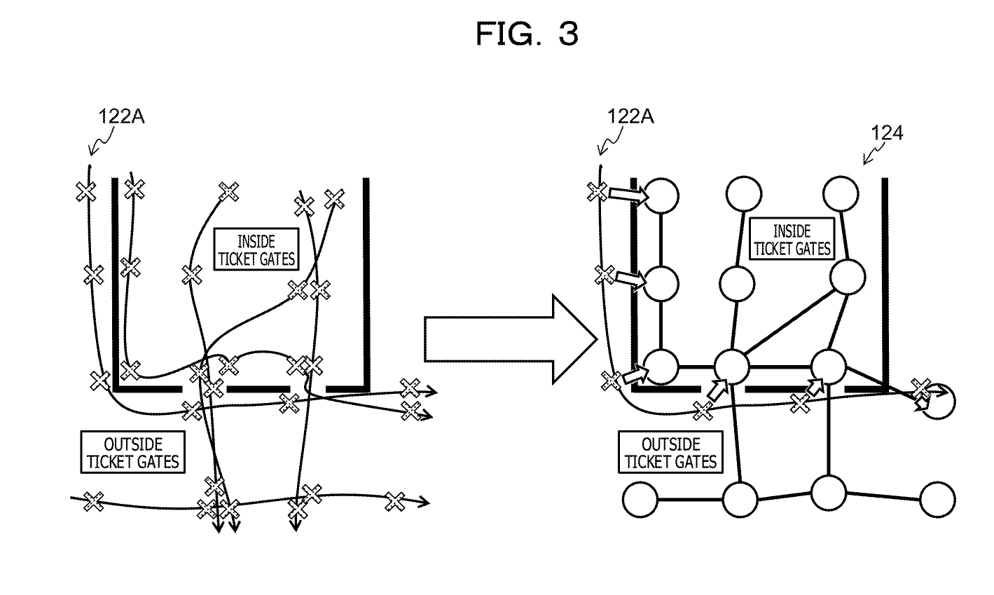

Here, as illustrated on the left side of FIG. 3, consider the case where each of the plurality of locus data 122 is mixed in an area inside ticket gates of a station and in an area outside the ticket gates. For example, locus data 122A of a moving body that moves along positions in the area outside the ticket gates and adjacent to an area inside the ticket gates is integrated into the path graph 124 generated by integrating the other locus data. When the locus data 122 is integrated with the path graph 124, the path of the locus data 122 is integrated into a path of the path graph 124 having a short distance with the locus data 122. In this case, if the locus data 122 is integrated into the path graph 124 only because of the short distance, as illustrated on the right side of FIG. 3, the locus data 122A which is outside the ticket gates is integrated into a part of the path inside the ticket gates among the path graph 124. In this manner, it is not possible to correctly analyze a flow of people inside the ticket gates or outside the ticket gates, the number of people passing the ticket gates, and the like by the generated path graph 124.

Thus, in the following embodiments, a path graph is generated in consideration of the difference in areas.

In the following, a detailed description will be given of an example of the embodiments of the present disclosure with reference to the drawings. In the present embodiment, as an example of the difference in areas, a description will be given of the case of generating a path graph in consideration of the difference between an area inside the ticket gates of a station and an area outside the ticket gates in the same manner as the example in FIG. 3.

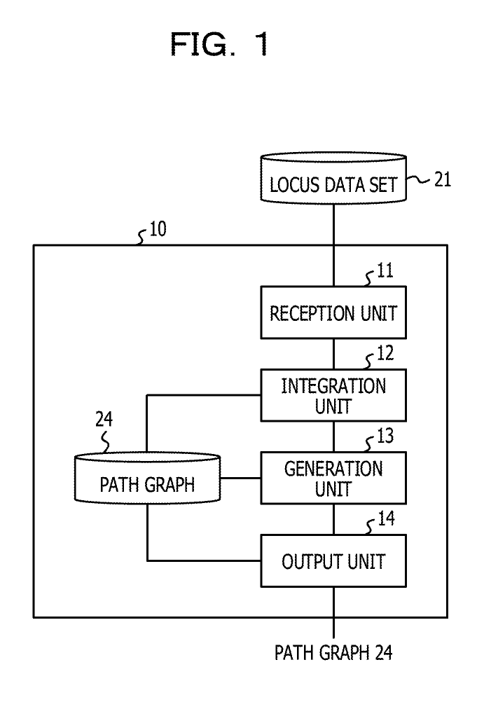

As illustrated in FIG. 1, a path graph generation device 10 according to the present embodiment receives a locus data set 21 as input. The path graph generation device 10 then integrates each of the locus data included in the locus data set 21 so as to generate and output a path graph 24.

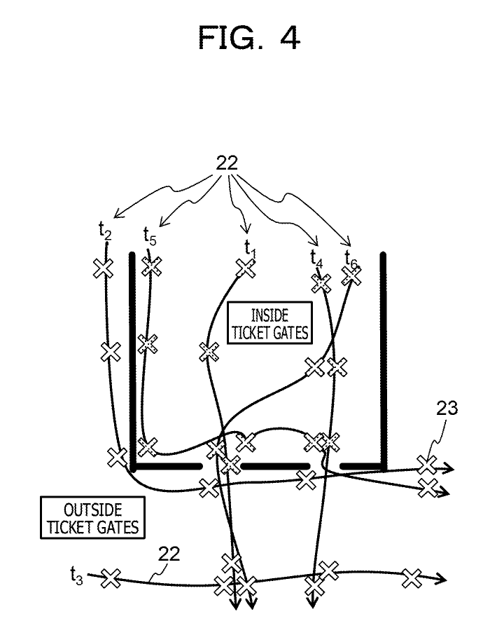

The locus data set 21 is a set of locus data 22 representing loci schematically illustrated in FIG. 4, for example. Each of the locus data 22 is a series of observation data indicating positions of a moving body, which is observed by a sensor that observes the positions of the moving body at predetermined time intervals. In the present embodiment, locus data representing people movement inside the ticket gates of a station and outside the ticket gates is handled. The sensor is, for example a GPS device, or the like, which is mounted on a terminal carried by a person, such as a mobile phone, a smartphone, or the like.

The observation data includes a sensor ID for identifying a sensor, position data (x-coordinate and y-coordinate) indicated by a latitude and a longitude for each observed position (observation point 23, x mark in FIG. 4), and observation time. The locus data 22 is produced by extracting a plurality of observation data for each sensor ID, and arranging the observation points 23 included in each observation data in time series based on the observation time. When the locus data 22 has a same sensor ID, if an observation time period between observation points 23 are equal to or longer than a predetermined time period, the locus data is divided at that point. In this case, a serial number is added to the sensor ID, or the like so as to give a uniquely identifiable locus ID to the locus data for each locus data. In the example in FIG. 4, each of t₁, t₂, t₃, t₄, t₅, and t₆ is a locus ID of a corresponding locus data 22. In the following, the locus data 22 having a locus ID of tᵢ is also expressed as “locus data tᵢ.”

Further, the locus data 22 in the present embodiment is provided with a label indicating whether the position denoted by the observation point 23 is inside the ticket gates or outside the ticket gates for each observation point 23. In the example in FIG. 4, an observation point 23 inside the ticket gates is indicated by a hatched x mark, and an observation point 23 outside the ticket gates is indicated by a solid-white x mark. The method of giving a label to an observation point 23 is not particularly limited. For example, using the position data included in the observation data indicating the observation point 23, it is possible to determine to which of a predetermined area inside the ticket gates or an area outside the ticket gates the observation point 23 belongs, and to give a determination result to the observation point 23 as a label.

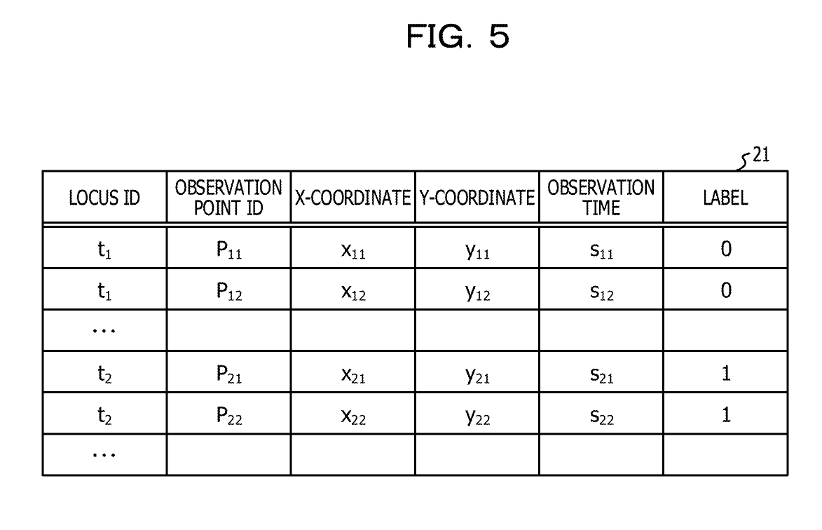

For example, it is assumed that the observation points 23 included in the locus data tᵢ are Pᵢ₁, Pᵢ₂, . . . , Pᵢⱼ, . . . , P_{iJ} (J is the number of observation points 23 included in the locus data tᵢ). In this case, it is possible to express the locus data tᵢ as tᵢ={Pᵢ₁, Pᵢ₂, . . . , Pᵢⱼ, . . . , Pᵢₖ}. The observation data indicating each of the observation points 23 includes a locus ID of the locus data 22 including the observation point 23, an observation point ID, which is the identification information of the observation points 23, position data (x-coordinate and y-coordinate), observation time, and label information. For example, it is possible to express the observation data of the observation point Pᵢⱼ included in the locus data tᵢ as Pᵢⱼ={tᵢ, Pᵢⱼ, (xᵢⱼ, yᵢⱼ), sᵢⱼ, 0}. The coordinates (x, yᵤ) are the position data of the observation point Pᵢⱼ, and sᵢⱼ is the observation time of the observation point Pᵢⱼ. In this example, the label indicating whether the position indicated by the observation point 23 is inside the ticket gates or outside the ticket gates is defined as “0=inside the ticket gates” and “1=outside the ticket gates”. In the following, the observation point having the observation point ID of Pᵢⱼ is also expressed as an “observation point Pᵢⱼ”. It is possible to express the locus data set 21 as illustrated in FIG. 5 using the above-described data structure, for example.

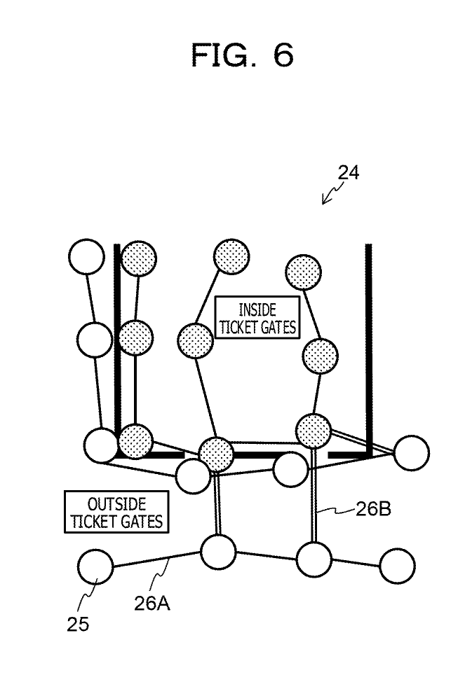

As described later, the path graph 24 is generated by integrating a plurality of locus data 22. As illustrated in FIG. 6, the path graph 24 is expressed by a plurality of nodes 25 and edges 26 that connect the nodes 25. A node 25 is an example of a representative position. In the present embodiment, a label indicating whether the position indicated by the node 25 is inside the ticket gates or outside the ticket gates is given to each of the nodes 25 in the same manner as each of the observation points 23 of the locus data 22 (the details will be described later). In the example in FIG. 6, a node 25 inside the ticket gates is denoted by a hatched circle mark, and a node 25 outside the ticket gates is denoted by a solid-white circle mark. For an edge 26, there are two types of edges, that is to say, a normal edge 26A that connects the nodes 25 having the same label, and a cross-type edge 26B that connects the nodes 25 having different labels. In FIG. 6, a normal edge 26A is denoted by a single line, and a cross-type edge 26B is denoted by a double line. When the two kinds of edges are described without distinction, the edge is simply referred to as an “edge 26”.

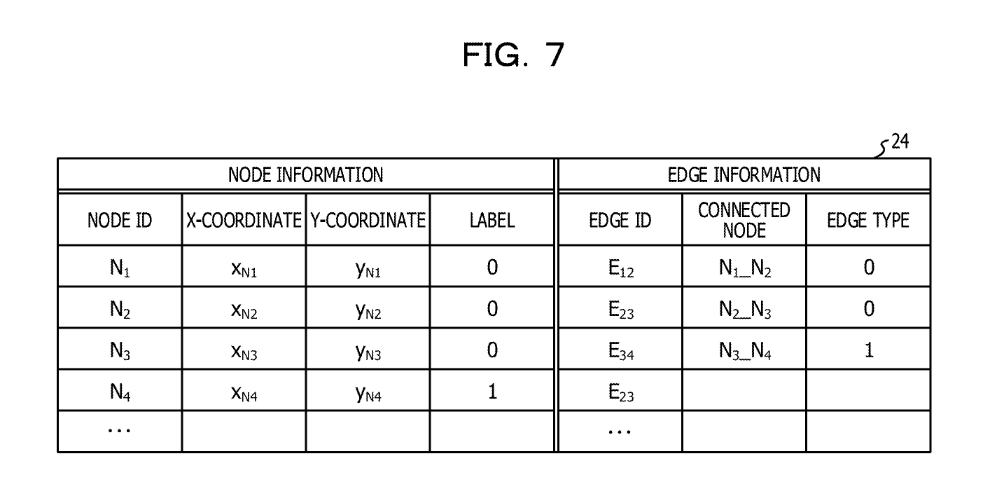

As illustrated in FIG. 7, it is possible to express the data structure of the path graph 24 by a set of node information indicating nodes 25 and a set of edge information indicating edges 26 which are included in the path graph 24. The node information includes, for example, identification information (node ID) of each node 25, position data (x-coordinate and y-coordinate) of each of the nodes 25, and label information. The edge information includes identification information (edge ID) of each of the edges 26, connected node information in which the nodes 25 connected by the edge 26 are denoted by a connection of the node IDs with “_(underbar)”, and the type information of the edge 26. In the example in FIG. 7, the types of edges 26 are defined as “0=normal edge” and “1=cross-type edge”. In the following, a node having a node ID of Nᵢ is also denoted by a “node Nᵢ”.

The path graph generation device 10 functionally includes a reception unit 11, an integration unit 12, a generation unit 13, and an output unit 14.

The reception unit 11 passes each of the locus data 22 included in the locus data set 21 that was input into the path graph generation device 10 to the integration unit 12.

The integration unit 12 determines whether or not each of the observation points 23 included in each of locus data 22 satisfies a proximity distance criterion with the observation points 23 included in the other locus data 22. Satisfying the proximity distance criterion is referred to as the case where the distance between the observation points 23 is less than or equal to a predetermined distance E. If the labels given to the respective observation points 23 that satisfy the proximity distance criterion are the same, that is to say, if the positions indicated by the observation points 23 belong to the same area (inside the ticket gates or outside the ticket gates), the integration unit 12 integrates the plurality of observation points 23 into the same node 25.

In the present embodiment, locus data is integrated into a path graph 24 generated at the current stage one by one, and at the stage when all the locus data 22 included in the locus data set 21 has been completed in integration, the path graph 24 is output as a final path graph 24. Accordingly, “integrating a plurality of observation points 23 into the same node 25” described above corresponds to the fact that the observation points 23 satisfying the proximity distance criterion and having the same label are integrated into the node 25 in the present embodiment.

If there are no nodes 25 that satisfy the proximity distance criterion with each of the observation points 23 included in each of the locus data 22, or if there is a node 25 that satisfies the proximity distance criterion, but does not have the same label, the integration unit 12 generates a new node 25 corresponding to the observation point 23. The integration unit 12 gives the same label as that of the corresponding observation point 23 to the generated node 25. The integration unit 12 adds node information indicating the generated node 25 to the data structure of the path graph 24 as illustrated in FIG. 7, for example.

If a node 25 is generated by the integration unit 12, the generation unit 13 connects the node 25 with an edge 26 to generate a path graph 24. Specifically, the generation unit 13 connects the node 25 that is newly generated by the integration unit 12 to a node 25 corresponding to the observation point 23 immediately before the observation point 23 corresponding to that node 25 with an edge 26. At this time, if the newly generated node 25 and the node 25 corresponding to the immediately before observation point 23 have the same given labels, the generation unit 13 connects the nodes 25 with a normal edge 26A node 25. On the other hand, if the newly generated node 25 and the node 25 corresponding to the immediately before observation point 23 have different labels, the generation unit 13 connects the nodes 25 with a cross-type edge 26B.

The integration unit 12 adds the edge information indicating the edge 26 that has connected the nodes 25 to the data structure of the path graph 24 as illustrated in FIG. 7, for example.

Thereby, a segment of the locus data 22, which is constituted by the observation points 23 that belong to the inside of the ticket gates, is associated with a part representing a path inside the ticket gates among the path graph 24. The segment of the locus data 22, which is constituted by the observation points 23 that belongs to the outside the ticket gates, is associated with a part representing a path outside the ticket gates among the path graph 24. That is to say, in the path graph 24, it is possible to distinguish a path inside the ticket gates from a path outside the ticket gates. Even if the locus data 22 crosses inside and outside the ticket gates, it is possible to consecutively associate a path inside the ticket gates and a path outside the ticket gates with the graph 24 without stopping association on the way. Accordingly, it is possible to generate a path graph 24 in which a path inside the ticket gates and a path outside the ticket gates are connected.

The output unit 14 outputs a finally generated path graph 24.

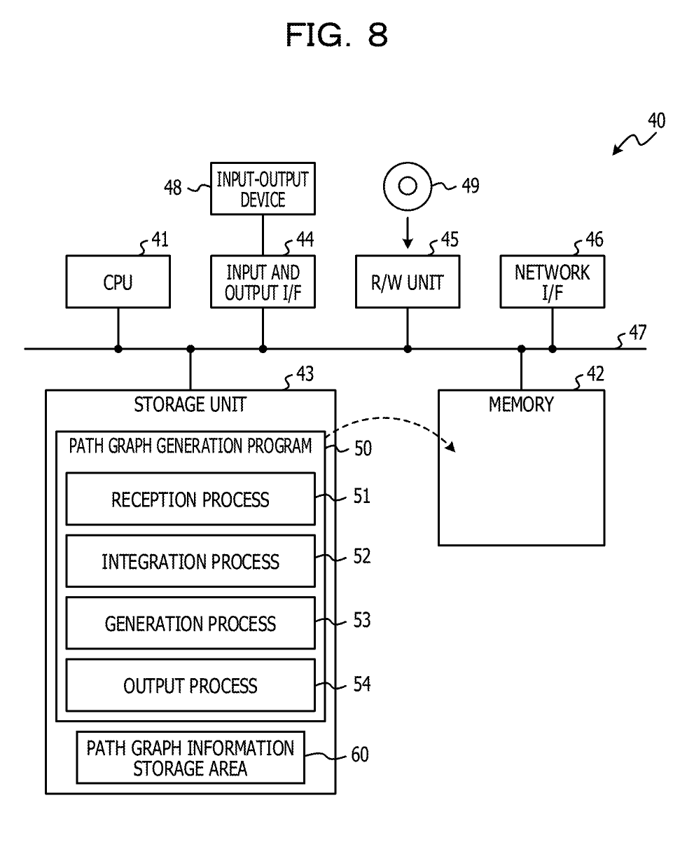

It is possible to actualize the path graph generation device 10 by a computer 40 illustrated in FIG. 8, for example. The computer 40 includes a CPU 41, a memory 42 as a temporary storage area, and a nonvolatile storage unit 43. The computer 40 includes an input and output interface (I/F) 44 to which an input-output device 48, such as a display device, an input device, and the like are coupled. The computer 40 includes a read and write (R/W) unit 45 that controls reading data to and writing data from a recording medium 49, and a network I/F 46 that is coupled to a network, such as the Internet, or the like. The CPU 41, the memory 42, the storage unit 43, the input and output I/F 44, the R/W unit 45, and the network I/F 46 are mutually coupled via a bus 47.

It is possible to actualize the storage unit 43 by a hard disk drive (HDD), a solid state drive (SSD), a flash memory, or the like. The storage unit 43 as a storage medium stores a path graph generation program 50 for causing the computer 40 to execute as the path graph generation device 10. The storage unit 43 includes a path graph information storage area 60 in which information of the path graph 24 including the node information and the edge information as illustrated in FIG. 7 are stored, for example.

The CPU 41 reads the path graph generation program 50 from the storage unit 43 and loads the program into the memory 42. The CPU 41 then executes the processes possessed by the path graph generation program 50 in sequence. The CPU 41 reads the node information and the edge information from the path graph information storage area 60, and expands the path graph 24 in the memory 42.

The path graph generation program 50 includes a reception process 51, an integration process 52, a generation process 53, and an output process 54. The CPU 41 executes the reception process 51 so as to operate as the reception unit 11 illustrated in FIG. 1. The CPU 41 executes the integration process 52 so as to operate as the integration unit 12 illustrates in FIG. 1. The CPU 41 executes the generation process 53 so as to operate as the generation unit 13 illustrates in FIG. 1. The CPU 41 executes the output process 54 so as to operate as the output unit 14 illustrated in FIG. 1. Thereby, the computer 40 that has executed the path graph generation program 50 functions as the path graph generation device 10.

It is possible to perform the functions that are achieved by the path graph generation program 50 by a semiconductor integrated circuit, more specifically, by an application specific integrated circuit (ASIC), or the like, for example.

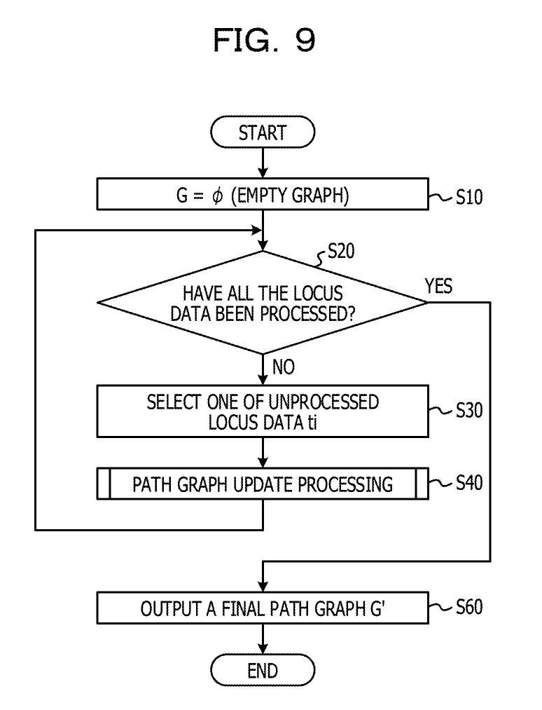

Next, a description will be given of the operation of the path graph generation device 10 according to the present embodiment. When the locus data set 21 is input into the path graph generation device 10, the path graph generation processing illustrated in FIG. 9 is executed by the path graph generation device 10.

In the path graph generation processing of S10 illustrated in FIG. 9, the reception unit 11 sets an empty graph as a path graph G indicating the path graph 24 generated at the current stage.

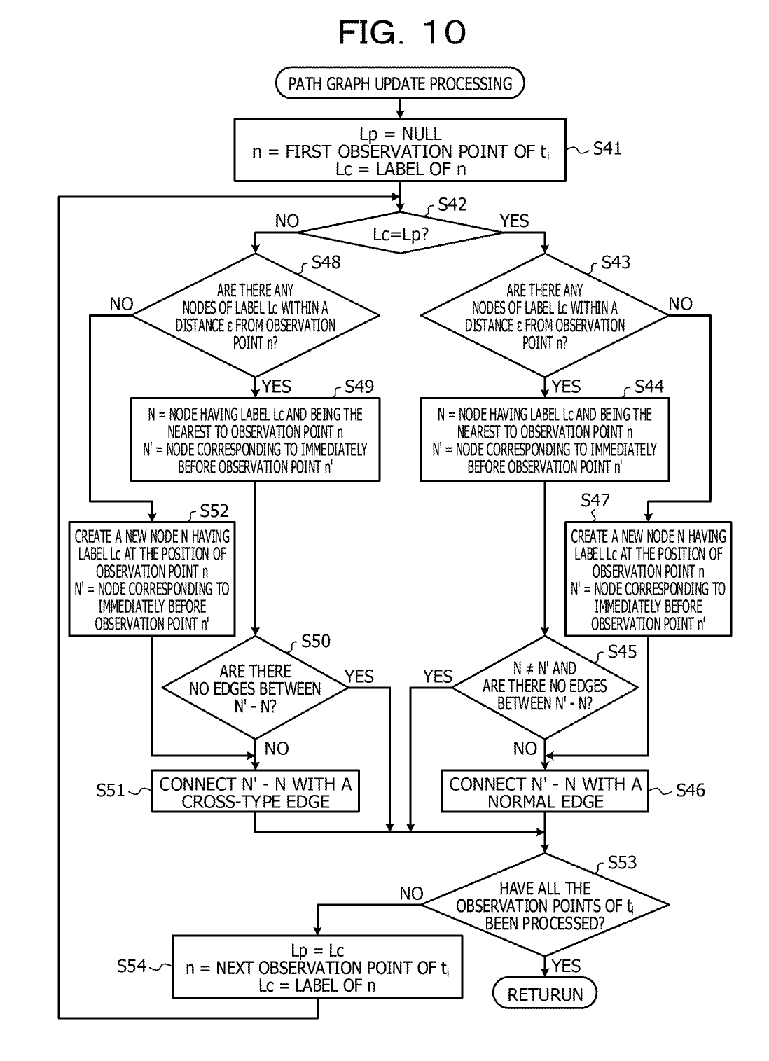

Next, in S20, the reception unit 11 determines whether processing for integrating into the path graph G have been completed for all the locus data tᵢ included in the input locus data set 21. If there is unprocessed locus data tᵢ, the processing proceeds to S30. In S30, the reception unit 11 selects one unprocessed locus data tᵢ from the locus data set 21 and passes the data to the integration unit 12. In the next S40, the path graph update processing, the details of which are illustrated in FIG. 10, is executed for the selected locus data tᵢ.

In the path graph update processing of S41 illustrated in FIG. 10, the integration unit 12 sets “NULL” in a variable Lp indicating a label of the observation point 23 processed immediately before. The integration unit 12 sets the first observation point Pᵢ₁ (the observation point 23 having the oldest observation time) of the locus data tᵢ in the variable n indicating the observation point 23 to be processed. Further, the integration unit 12 sets the label of the observation point (in the following, denoted as “observation point n”) that has been set to n in the variable Lc indicating the label of the observation point 23 to be processed.

Next, in S42, the integration unit 12 determines whether or not Lc and Lp are equal, that is to say, determines whether or not the observation point n to be processed and the observation point 23 (in the following, denoted as “observation point n′”) processed immediately before have the same label. If determined that Lc=Lp, the processing proceeds to S43. If determined that Lc≠Lp, the processing proceeds to S48.

In S43, the integration unit 12 determines whether there are nodes 25 having a label of Lc within a distance E from the observation point n or not. If determined that there is a node 25, the processing proceeds to S44. On the other hand, if determined that there are no nodes 25, the processing proceeds to S47.

In S44, the generation unit 13 sets a node 25 that is nearest to the observation point n among the nodes 25 having the label Lc, which have been determined to be existent in the above-described S43, to the node N. The generation unit 13 sets a node 25 corresponding to the observation point n′ that has been processed immediately before to the node N′.

Next, in S45, the generation unit 13 determines whether the node N and the node N′ are not identical, and there are no edges 26 that connect the node N and the node N′. If determined to be No (N), the processing proceeds to S46, and the generation unit 13 connects the node N and the node N′ by a normal edge 26A. On the other hand, if the node N is equal to the node N′, or if the node N and the node N′ are already connected by the edge 26, the nodes do not have to be further connected by an edge, and thus the processing of S46 is skipped.

In S47, the generation unit 13 newly creates a node N having the label Lc at the position indicated by the position data included in the observation data indicating the observation point n. The generation unit 13 sets the node 25 corresponding to the observation point n′ processed immediately before to a node N′. The processing then proceeds to S46, and the generation unit 13 connects the node N and the node N′ by a normal edge 26A.

On the other hand, if determined that Lc≠Lp and the processing proceeds to S48, the integration unit 12 determines whether there are nodes 25 having the label of Lc within a distance of E from the observation point n in the same manner as the above-described S43. If determined that there is a node 25 having the label of Lc, the processing proceeds to S49. On the other hand, if determined that there are no nodes 25, the processing proceeds to S52.

In S49, the generation unit 13 sets a node 25 that is the nearest to the observation point n to the node N in the same manner as the above-described S44. The generation unit 13 then sets a node 25 corresponding to the observation point n′ processed immediately before to the node N′.

Next, in S50, the generation unit 13 determines whether there are no edges 26 connecting the node N and the node N′ or not. If determined that there are no edges, the processing proceeds to S51. The generation unit 13 then connects the node N and the node N′ by a cross-type edge 268. On the other hand, if the node N and the node N′ are already connected by an edge 26, the processing of S51 is skipped.

In S52, the generation unit 13 newly creates a node N having a label of Lc at the position of the observation point n in the same manner as above-described S47, and sets a node 25 corresponding to the observation point n′ processed immediately before to the node N′. The processing then proceeds to S51. The generation unit 13 then connects the node N and the node N′ by a cross-type edge 268.

Next, in S53, the integration unit 12 determines whether or not the above-described processing has been completed for all the observation points included in the locus data tᵢ. If determined that there is an unprocessed observation point, the processing proceeds to S54. In S54, the integration unit 12 sets the label, which is currently set to Lc, to Lp, sets n to the observation point Pᵤ of the next observation time in the locus data tᵢ, and sets Lc to the label of the observation point n. The processing then returns to S42.

If determined that the above-described processing has been completed for all the observation points included in the locus data tᵢ, the path graph update processing is terminated, and the processing returns to the path graph generation processing (FIG. 9).

Returning to the path graph generation processing of S20 illustrated in FIG. 9, if the reception unit 11 determines that processing for integrating into the path graph G has been completed for all the locus data tᵢ included in the locus data set 21, the processing proceeds to S60. In S60, the output unit 14 outputs the current path graph G as a final path graph G′, and the path graph generation processing is terminated.

Here, a description will be specifically given of the case where the locus data set 21 including the locus data tᵢ (i=1, 2, . . . , 6) as illustrated in FIG. 4 is input regarding the above-described path graph generation processing. In the following, a description will be given of the case where the locus data is selected in order of t₁, t₂, t₃, t₄, t₅, and t₆ in S30, and the processing of S40 is executed. Each of the locus data t, is represented by a series of observation points Pᵢⱼ described as follows.

t₁={P₁₁, P₁₂, P₁₃, P₁₄}

t₂={P₂₁, P₂₂, P₂₃, P₂₄, P₂₅, P₂₆}

t₃={P₃₁, P₃₂, P₃₃, P₃₄}

t₄={P₄₁, P₄₂, P₄₃, P₄₄}

t₅={P₅₁, P₅₂, P₅₃, P₅₄, P₅₅, P₅₆}

t₆={P₆₁, P₆₂, P₆₃, P₆₄}

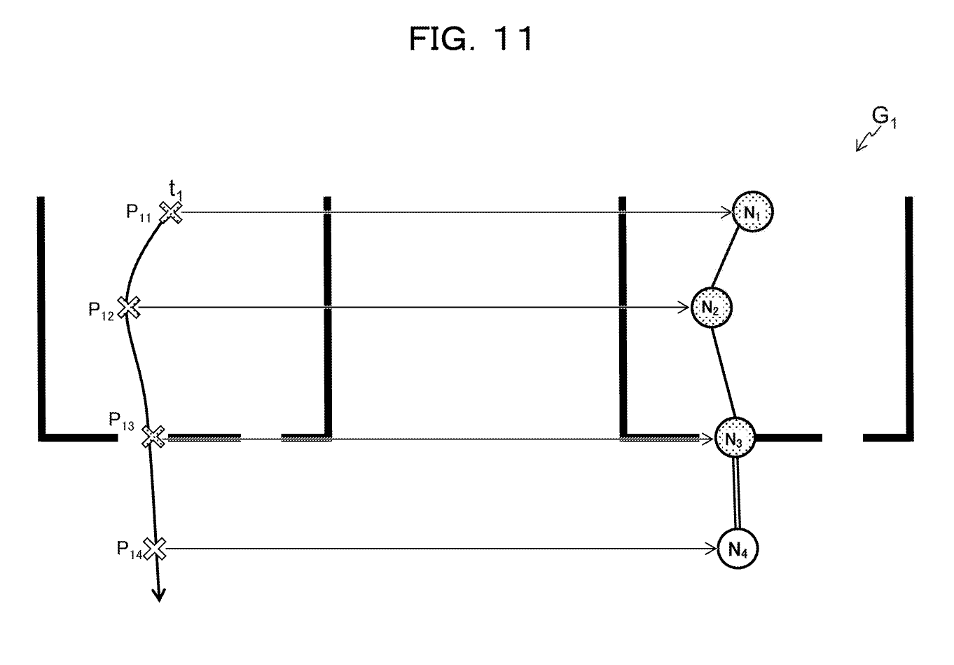

At a stage of integrating the locus data t₁ into the path graph G, the path graph G is an empty graph. Accordingly, as illustrated in FIG. 11, nodes N₁, N₂, N₃, and N₄ are generated at the positions of the observation points P₁₁, P₁₂, P₁₃, and P₁₄ of the locus data t₁, respectively. The labels that are given to the nodes N₁, N₂, and N₃ corresponding to the observation points P₁₁, P₁₂, and P₁₃, respectively are the labels indicating “inside the ticket gates” in the same manner as the labels that are given to the observation points P₁₁, P₁₂, and P₁₃. The label that is given to the node N₄ corresponding to the observation point P₁₄ is the label indicating “outside the ticket gates” in the same manner as the label given to the observation point P₁₄. Between the node N₁ and the node N₂, and between the node N₂ and the node N₃ are connected by normal edges 26A, because the labels of the nodes connected are the same. On the other hand, the labels of the nodes to be connected are different between the node N₃ and the node N₄, and thus the node N₃ and the node N₄ is connected by a cross-type edge 26B. The path graph G at the stage of having integrated the locus data t₁ is denoted by a path graph G₁.

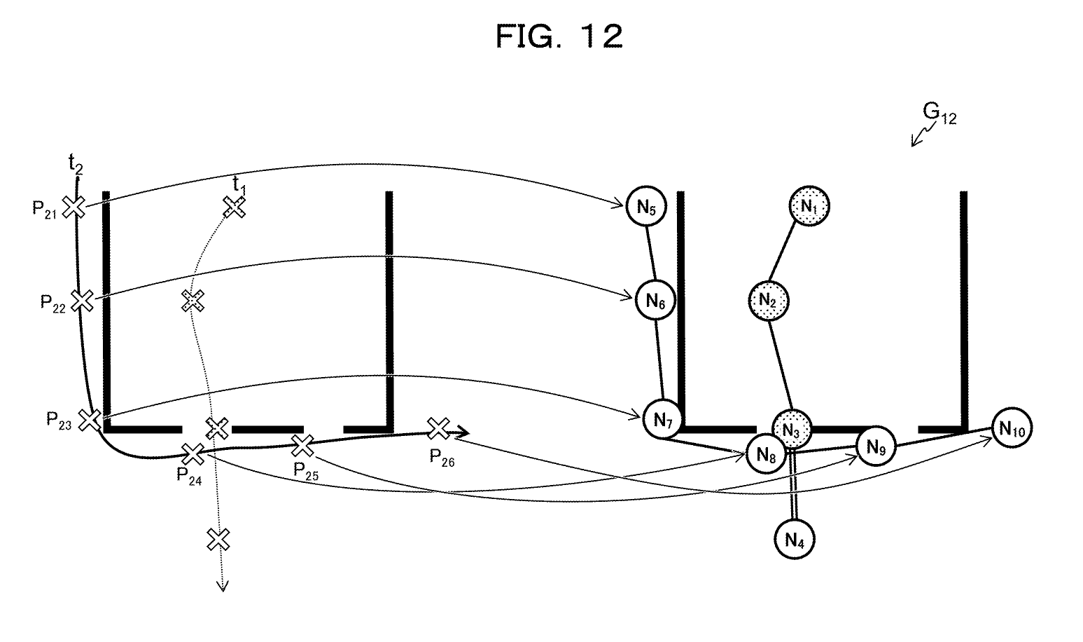

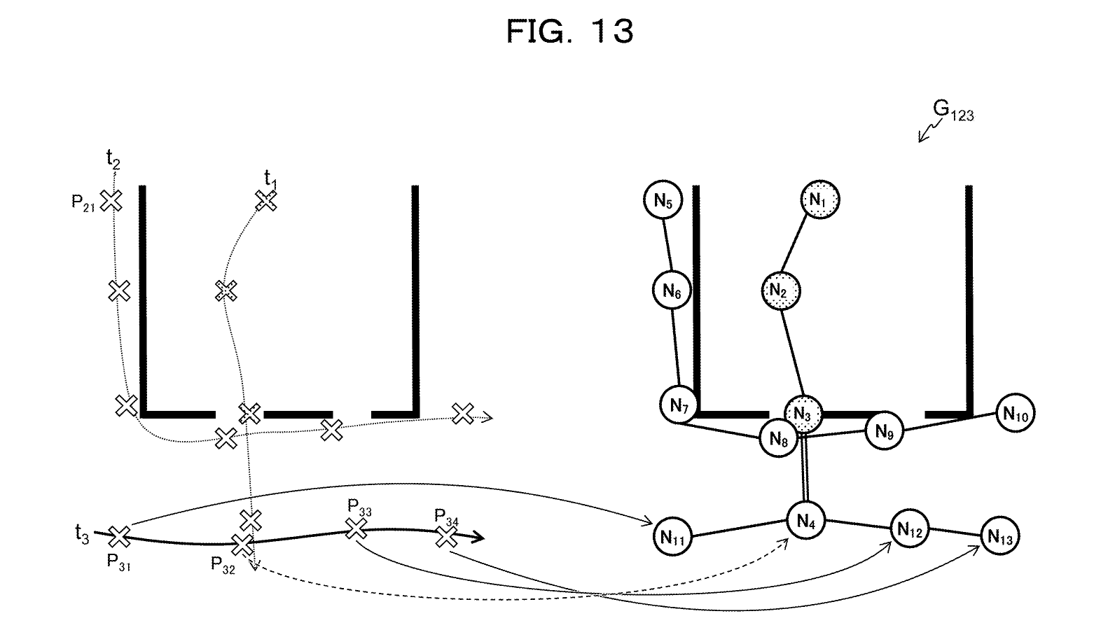

Next, as illustrated in FIG. 12, the locus data t₂ is integrated into the path graph G₁. In the left diagram in FIG. 12, the locus data to be processed is illustrated by a solid line, and the locus data that has been processed is illustrated by a dotted line. This is the same as in the following FIG. 13 to FIG. 16. Each of the observation points P₂₁, P₂₂, and P₂₃ of the locus data t₂ does not have a node 25 that satisfies the proximity distance criterion. Accordingly, nodes N₅, N₆, and N₇ having the same label as that of the observation points P₂₁, P₂₂, and P₂₃ are generated at the positions of the observation points P₂₁, P₂₂, and P₂₃, respectively. Between each of the nodes is then connected by a normal edge 26A. The next observation point P₂₄ satisfies the proximity distance criterion with the node N₃. However, the label of the observation point P₂₄ is “outside the ticket gates”, and the label of the node N₃ is “inside the ticket gates”. Thus, the observation point P₂₄ is not integrated into the node N₃, because both of the labels are different. Accordingly, a node N₈ having the same label as that of the observation point P₂₄ is generated at the position of the observation point P₂₄, and the node N₈ and the node N₇ that has been processed immediately before are connected by a normal edge 26A. For the observation points P₂₅ and P₂₆, the corresponding nodes N₉ and N₁₀ are generated, respectively, and are connected by a normal edge 26A. The path graph G at the stage of having integrated the locus data t₂ into the path graph G₁ is denoted by a path graph G₁₂.

Next, as illustrated in FIG. 13, the locus data t₃ is integrated into the path graph G₁₂. A node N₁₁ corresponding to the observation point P₃₁ of the locus data t₃ is generated. The next observation point P₃₂ satisfies the proximity distance criterion with the node N₄. The label of the observation point P₃₂ is “outside the ticket gates”, and the label of the node N₄ is also “outside the ticket gates” so that both of the labels are the same, and thus the observation point P₃₂ is integrated into the node N₄. That is to say, a new node corresponding to the observation point P₃₂ is not generated. For the observation points P₃₃ and P₃₄, corresponding nodes N₁₂ and N₁₃ are generated, respectively, and the nodes are connected by a normal edge 26A. The path graph G at the point of having integrated the locus data t₃ into the path graph G₁₂ is dented by a path graph G₁₂₃.

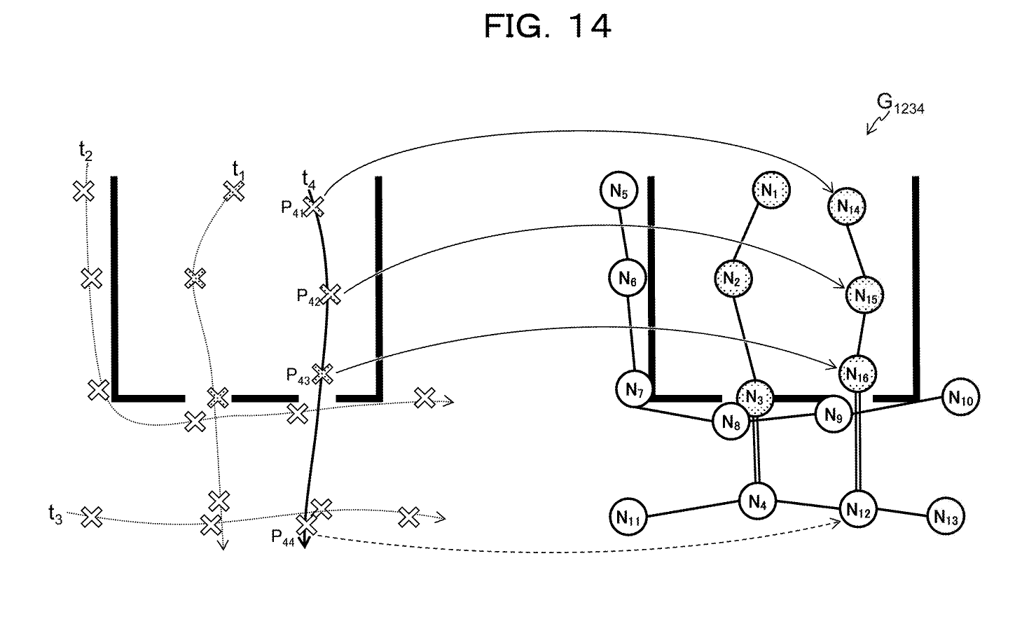

Next, as illustrated in FIG. 14, the locus data t₄ is integrated into the path graph G₁₂₃. For the observation points P₄₁, P₄₂, and P₄₃ of the locus data t₄, the corresponding nodes N₁₄, N₁₅, and N₁₆ are generated, respectively, and are connected by normal edges 26A. The next observation point P₄₄ satisfies the proximity distance criterion with the node N₁₂, and both of the labels are the same, and thus observation point P₄₄ is integrated into the node N₁₂. The node N₁₂ and the node N₁₆ processed immediately before have not been connected, and both of the labels are different. Accordingly, the node N₁₆ and the node N₁₂ are connected by a cross-type edge 26B. The path graph G at the stage of having integrated the locus data t₄ into the path graph G₁₂₃ is denoted by a path graph G₁₂₃₄.

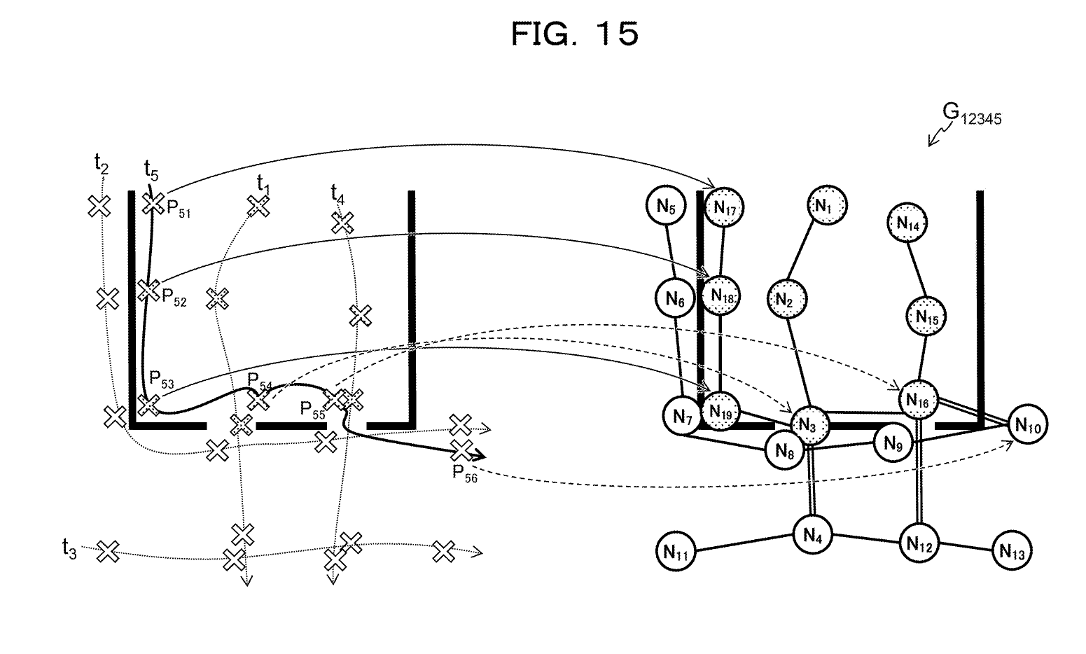

Next, as illustrated in FIG. 15, the locus data t₅ is integrated into the path graph G₁₂₃₄. The observation points P₅₁, P₅₂, and P₅₃ of the locus data t₅ satisfy the proximity distance criterion with the nodes N₅, N₆, and N₇, respectively, but have different labels, and thus are not integrated. Accordingly, nodes N₁₇, N₁₈, and N₁₉ corresponding to the observation points P₅₁, P₅₂, and P₅₃, respectively are generated, and are connected by normal edges 26A. The next observation point P₅₄ is integrated into the node N₃ with which the observation point P₅₄ satisfies the proximity distance criterion, and has the same label. Between the nodes N₁₉-N₃ is connected by a normal edge 26A. The next observation point P₅₅ is integrated into the node N₁₆ with which the observation point P₅₅ satisfies the proximity distance criterion, and has the same label. Between the nodes N₃-N₁₆ are connected by a normal edge 26A. The next observation point P₅₆ is integrated into the node N₁₀ with which the observation point P₅₆ satisfies the proximity distance criterion, and has the same label. The node N₁₀ and the node N₁₆ that has been processed immediately before have different labels, and thus between the nodes N₁₆-N₁₀ is connected by a cross-type edge 26B. The path graph G at the stage of having integrated the locus data t₅ into the path graph G₁₂₃₄ is denoted by a path graph G₁₂₃₄₅.

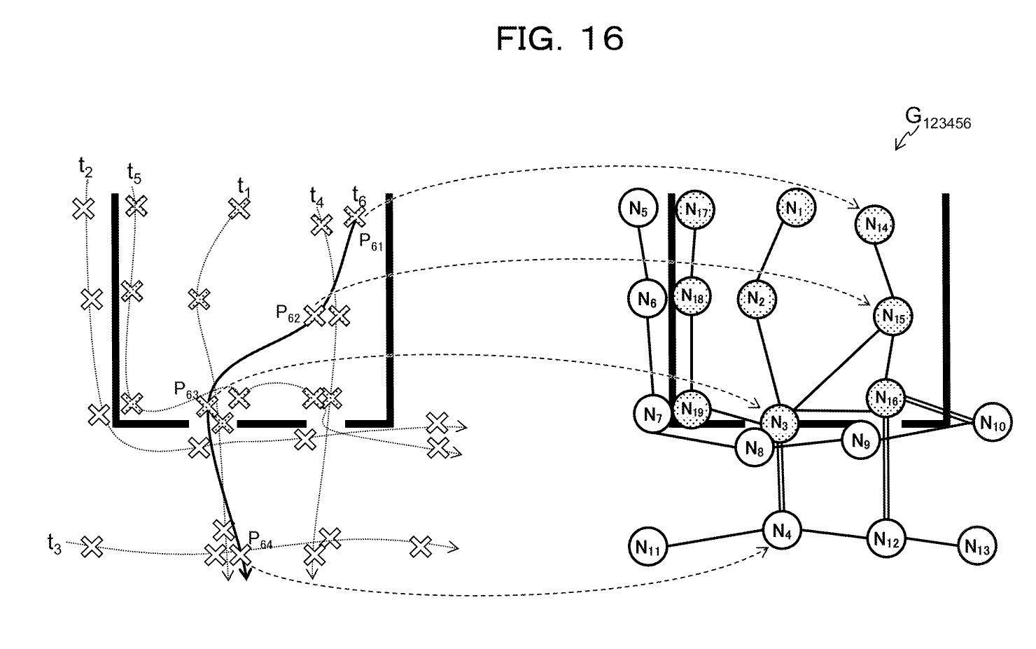

Next, as illustrated in FIG. 16, the locus data t₆ is integrated into the path graph G₁₂₃₄₅. The observation points P₆₁, P₆₂, P₆₃, and P₆₄ of the locus data t₆ are integrated into the nodes N₁₄, N₁₅, N₃, and N₄ because of satisfying the proximity distance criterion with the nodes N₁₄, N₁₅, N₃, and N₄, and have the same labels as those of the nodes N₁₄, N₁₅, N₃, and N₄, respectively. Between the nodes N₁₅-N₃, which has not been connected by an edge, is newly connected by a normal edge 26A. The path graph G at the stage of having integrated the locus data t₆ into the path graph G₁₂₃₄₅ is denoted by a path graph G₁₂₃₄₅₆. The path graph G₁₂₃₄₅₆ becomes a path graph G′, which is finally output.

As described above, with the path graph generation device according to the present embodiment, each of the observation points included in the locus data is provided with a label in accordance with an area to which the position indicated by the observation point belongs. Next, at the time of integrating the locus data into the path graph, each of the observation points is integrated into a node with which the observation point satisfies the proximity distance criterion and has the same label. The node is provided with the same label as the label that has been given to the observation point integrated to that node. Thereby, it is possible to generate a path graph in consideration of the difference in areas.

Between the nodes to which different labels are given, an edge different from the edge that connects the nodes having the same label is used for connection, and thus it is possible to associate locus data that crosses different areas with a path graph without stopping association.

By matching the locus data with the generated path graph and making an analysis as described above, it is possible to analyze a flow of people passing in each of the areas inside and outside the ticket gates, and people passing through the ticket gates, a flow rate, and the like. It is also possible to analyze a detailed flow of people before and after passing a ticket gate, for example among people who have passed the leftmost ticket gate, the larger number of people turn left than the number of people who go straight, or the like. The locus data to be used for matching may be the locus data used for generating a path graph, or may be the other locus data. The matching of the locus data with the path graph means that each of the observation points included in the locus data is associated with any one of the nodes in a path graph based on the proximity of the distance, and the locus indicated by the locus data is associated with any one of paths included in a path graph.

When a flow rate of a moving body is obtained using a path graph, the flow rate ought to be obtained based on the number of observation points associated with each of the nodes of the path graph at the time of matching the locus data with the path graph.

At the time of generating a path graph, the number of observation points integrated into each node may be held as information on a flow rate. Further, at the time of displaying a path graph on a screen, or the like, the width, the color, the type of line of an edge between the nodes, or the like may be changed in accordance with information on the flow rate held by the nodes on both ends of the edge.

In the above-described embodiment, a description has been given of the case where an area is distinguished by the difference in an area inside the ticket gates and an area outside the ticket gates. However, the present disclosure is not limited to this. For example, each booth in an exhibition hall, each store at a department store, or the like may be used as a respective area.

Further, the difference in areas is not limited to the difference in physical (on a two-dimensional plane) areas. The difference in areas may be the difference in conceptual areas, for example, the difference in areas may be distinguished by whether inside an area, such as in a vehicle, on a train, or the like or outside the area. In this case, for example, a label indicating moving on foot, or moving in a car, or the like ought to be given to each of the observation points of the locus data. For a method of giving a label, for example, it is possible to obtain a speed of a moving body for each observation point from the distance between the individual observation points among the locus data and the observation time, to determine whether on foot or travel by car from the moving average of the speed at a predetermined number of observation points, or the like in order to give the label. If a person rides in a taxi, or the like, the locus data observed by a GPS device mounted on a mobile terminal held by the person substantially matches the locus data observed by a GPS device mounted on a car navigation system of the taxi in which the person rode. Using such information, it is possible to give a label indicating the difference between on foot and travel by car to the locus data of that person. A sensor, such as a GPS device, or the like ought to be set so as to make it possible to give information on transportation measures to the observation data.

When a path graph is generated in consideration of the difference in conceptual areas like this, it is possible to make a detailed path analysis in consideration of changing transportation measures. For example, it is possible to analyze a movement path of a person up to the point in time of riding in a taxi, a movement path of a person after riding in a taxi, or the like.

For the information for distinguishing by a label, in addition to an area, or a transportation device, a period of time to which the observation time of each observation point belongs, an attribute (gender in the case of a person, a vehicle type, or the like in the case of a vehicle) of a moving body, or the like may be applied.

In the above, a description has been given of the mode in which the path graph generation program 50 is stored (installed) in the storage unit 43 in advance. However, the present disclosure is not limited to this. It is possible to provide a program according to the disclosed technique in the mode of being recorded on a recording medium, such as a CD-ROM, a DVD-ROM, a USB memory, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A path graph generation method executed by a processor included in a path graph generation device, the method comprising:
acquiring a plurality of pieces of locus information regarding a plurality of moving bodies, the locus information including each information on a plurality of positions acquired at predetermined time intervals, each of the plurality of positions being associated with a label indicating a belonging area;
determining, for each of the plurality of pieces of locus information, whether to integrate two or more positions having an each other's distance less than or equal to a predetermined distance among the plurality of positions into one position, based on the label associated with each of the two or more positions; and
setting the one position to a node position and thereby generating the path graph, when it is determined to integrate the two or more positions into the one position.

2. The path graph generation method according to claim 1,
wherein the determining includes determining to integrate the two or more positions into the one position, when it is determined that the two or more positions belong to a same area based on the label.

3. The path graph generation method according to claim 1,
wherein the generating includes suppressing integration of the two or more positions into the one position, when it is determined that the two or more positions having the each other's distance less than or equal to a predetermined distance belong to different areas, respectively based on the label.

4. The path graph generation method according to claim 1,
wherein the generating includes coupling a node belonging to a first area and a node belonging to a second area different from the first area with adding information indicating a connection between nodes belonging to different areas, when one of two positions corresponding to consecutive two times among a plurality of positions, the plurality of positions having different corresponding times of a moving body among the plurality of moving bodies, has a distance less than or equal to the predetermined distance from a position of the node belonging to the first area, and when another position of the two positions has a distance less than or equal to the predetermined distance from a position of the node belonging to the second area.

5. The path graph generation method according to claim 3,
wherein the generating includes:
coupling nodes belonging to a same area with a first edge, and
coupling a node belonging to the first area and a node belonging to the second area with a second edge different from the first edge.

6. The path graph generation method according to claim 1,
wherein the generating includes updating the path graph by setting the position as a new node, when it is determined that there are no nodes having a distance from a position included in the plurality of pieces of locus information less than or equal to the predetermined distance based on the latest path graph, or when it is determined that there are no nodes belonging to a same area as an area to which the position belongs among a plurality of nodes having a distance less than or equal to the predetermined distance from the position and included in the latest path graph.

7. The path graph generation method according to claim 1,
wherein the plurality of pieces of locus information is information obtained by a sensor possessed by each of the plurality of moving bodies.

8. The path graph generation method according to claim 7,
wherein the sensor is a Global Positioning System (GPS) device.

9. A path graph generation device comprising:
a memory; and
a processor coupled to the memory and configured to:
acquire a plurality of pieces of locus information regarding a plurality of moving bodies, the locus information including each information on a plurality of positions acquired at predetermined time intervals, each of the plurality of positions being associated with a label indicating a belonging area,
determine, for each of the plurality of pieces of locus information, whether to integrate two or more positions having an each other's distance less than or equal to a predetermined distance among the plurality of positions into one position, based on the label associated with each of the two or more positions, and
set the one position to a node position and thereby generating the path graph, when it is determined to integrate the two or more positions into the one position.

10. A non-transitory computer-readable storage medium storing a program that causes a processor included in a path graph generation device to execute a process, the process comprising:
acquiring a plurality of pieces of locus information regarding a plurality of moving bodies, the locus information including each information on a plurality of positions acquired at predetermined time intervals, each of the plurality of positions being associated with a label indicating a belonging area;
determining, for each of the plurality of pieces of locus information, whether to integrate two or more positions having an each other's distance less than or equal to a predetermined distance among the plurality of positions into one position, based on the label associated with each of the two or more positions; and
setting the one position to a node position and thereby generating the path graph, when it is determined to integrate the two or more positions into the one position.
